(19) United States
(12) Patent Application Publication
(10) Pub. No.: US 2019/0385136 A1
(43) Pub. Date: Dec. 19, 2019

(54) System and Method for Generating Permanent Data Records and Assets for Digital Items in a Networked Video Game System

(71) Applicant: Enjin PTE LTD, Singapore (SG)

(72) Inventors: Maxim Blagov, Singapore (SG); Witold Radomski, Singapore (SG)

(73) Assignee: Enjin PTE LTD

(21) Appl. No.: 16/007,124

(22) Filed: Jun. 13, 2018

(51) Int. Cl. G06Q 20/12; G06Q 20/06

(52) U.S. Cl. CPC G06Q 20/123; G06Q 2220/00; G06Q 20/065

(57) ABSTRACT

An improved system for generating and tracking digital items in a networked video game system using blockchain technology are disclosed. The system records the sale of a digital item in a blockchain and allocates a reserve of cryptocurrency for the digital item. Thereafter, the digital item can be returned or cancelled in exchange for the cryptocurrency.

### FIELD OF THE INVENTION

An improved system for generating and tracking digital items in a networked video game system using blockchain technology are disclosed. The system records the sale of a digital item in a blockchain and allocates a reserve of cryptocurrency for the digital item. Thereafter, the digital item can be returned or cancelled in exchange for the cryptocurrency.

### BACKGROUND OF THE INVENTION

Blockchain technology is known in the prior art. At a high level, a blockchain is an open, distributed ledger that can record transactions between two parties in a verifiable and permanent way. A blockchain comprises one or more blocks. Each block comprises a cryptographic hash of the previous block in the blockchain, a timestamp, and a ledger containing transaction data.

FIG. 1 depicts blockchain 100ᵢ, where “i” is the iteration number of blockchain 100, where each iteration contains one additional block compared to the previous iteration.

Blockchain 100ᵢ comprises blocks 101₁, 101₂, . . . , block 101ᵢ. For simplicity, only block 101ᵢ is shown in FIG. 1. Block 101ᵢ comprises header 102, and ledger 103ᵢ.

Header 102ᵢ comprises hash 104ᵢ of the previous block or the header of the previous block, which here is block 101ᵢ₋₁. Hash 104ᵢ can be created using known hash function techniques, which create a cryptographic hash of fixed length based on the input, which here are the contents of block 101ᵢ₋₁ or the header of block 101ᵢ₋₁. Hash 104ᵢ is a mechanism for authenticating block 101ᵢ, as only a trusted computing device that contains the contents of block 101ᵢ₋₁ or the header of block 101ᵢ₋₁ and the algorithm for the cryptographic hash function will have been able to create hash 104ᵢ of block 101ᵢ₋₁ or its header. An example of a cryptographic hash function is the SHA 256 function, which generates a 256 bit (32 byte) hash output for any given input.

Header 102ᵢ also comprises timestamp 105ᵢ, which is the date and time at which block 101ᵢ was created. Header 102ᵢ optionally comprises difficulty 106ᵢ (which can be a “proof-of-work” algorithm difficulty target for the block), nonce 107ᵢ (which is a counter used for the proof-of-work algorithm), and Merkle root 108ᵢ (which is a summary or hash of the transactions contained in ledger 103ᵢ). Header 102ᵢ can include other information as desired.

Ledger 103i comprises data for one or more transactions that are recorded in block 101ᵢ. In this example, ledger 103 comprises transactions 109_{iA} and 109_{iB}. Various data structures can be used for transactions 109. Typically, transactions 109 will comprises data indicating the parties involved in the transaction, the subject matter of the transaction, the terms of the transaction, and other relevant information.

FIGS. 2 and 3 contain further examples of a prior art blockchain. FIG. 2 depicts blockchain 100₁, which here represents the very first iteration of the blockchain. Blockchain 100₁ comprises only one block, block 101₁. Block 101₁ sometimes is referred to as “the genesis block,” as it is the first block that starts a blockchain.

Block 101₁ comprises header 102₁ and ledger 103₁. Header 102₁ comprises hash 104₁ of block 101₀. Here, block 101₀ does not actually exist (as block 101₁ is the first block of the blockchain), so hash 104₁ will be blank or null in this instance. Ledger 103₁ comprises three transactions, transactions 109_{1A}, 109_{1B}, and 109_{1C}.

FIG. 3 depicts blockchain 100₂, which is the next iteration of blockchain 100₁ after another block, block 101₂, has been added. Block 101₂ comprises header 102₂ and ledger 103₂. Header 102₂ comprises hash 104₂ of block 101₁ or of header 102₁. Ledger 103₂ comprises two transactions, transaction 109_{2A} and 109_{2B}.

Blocks and blockchains are generated, stored, and retrieved by computing devices. A computing device that generates and/or stores blockchains is referred to as a “node.”

FIG. 4 depicts hardware components of exemplary computing device 400 that can operate as a node. These hardware components are known in the prior art. Computing device 400 is a computing device that comprises processing unit 401, memory 402, non-volatile storage 403, positioning unit 404, network interface 405, image capture unit 406, graphics processing unit 407, and display 408. Computing device 400 can be a server, notebook computer, desktop computer, game system, smartphone, or other computing device, and blockchain processing engine 502 can be a software application running on computing device 400.

Processing unit 401 optionally comprises a microprocessor with one or more processing cores. Memory 402 optionally comprises DRAM or SRAM volatile memory. Non-volatile storage 403 optionally comprises a hard disk drive or flash memory array. Positioning unit 404 optionally comprises a GPS unit or GNSS unit that communicates with GPS or GNSS satellites to determine latitude and longitude coordinates for computing device 400, usually output as latitude data and longitude data. Network interface 405 optionally comprises a wired interface (e.g., Ethernet interface) or wireless interface (e.g., 3G, 4G, GSM, 802.11, protocol known by the trademark “Bluetooth,” etc.). Image capture unit 406 optionally comprises one or more standard cameras (as is currently found on most smartphones and notebook computers). Graphics processing unit 407 optionally comprises a controller or processor for generating graphics for display. Display 408 displays the graphics generated by graphics processing unit 407, and optionally comprises a monitor, touchscreen, or other type of display.

FIG. 5 depicts software components of computing device 400. Computing device 400 comprises operating system 501 (such as the operating systems known by the trademarks “Windows,” “Linux,” “Android,” “iOS,” or others) and blockchain processing engine 502. Blockchain processing engine 502 comprises lines of software code executed by processing unit 401 to perform the functions described below. The prior art includes examples of blockchain processing engine 502, but as discussed in greater detail below, the embodiments of the present invention include improvements to prior art blockchain processing engines to provide additional functionality not available in the prior art.

FIGS. 6A-6E depict an exemplary prior art system and method for generating blockchains.

With reference to FIG. 6A, computing device 400ᵢ stores blockchain 100₁. Computing device 400ᵢ might be the device that generated blockchain 100₁, or it might merely be a device that is storing blockchain 100₁, which was generated by a different computing device 400.

With reference to FIG. 6B, computing device 400₂ wishes to add block 101₂ to blockchain 100₁ to create blockchain 100₂. It first does so locally, using its blockchain processing engine 502 to generate blockchain 100₂, and it then seeks to have all other computing devices 400 that have stored blockchain 100₁ (i.e., other nodes) to add block 101₂ to blockchain 100₁ to generate blockchain 100₂.

With reference to FIG. 6C, computing device 400₁ receives the request from computing device 400₂. Blockchain processing engine 502 in computing device 400₁ compares a hash of block 101₁ stored in blockchain 100₁ or its header to the hash stored in header 104₂ of block 101₂. If there is a match, computing device 400₁ knows that the request is legitimate, and it then updates blockchain 100₁ to add block 101₂ to the chain, thus resulting in blockchain 100₂, shown in FIG. 6D. Computing devices 400₁ and 400₂ can store blockchains 100₁ and 100₂ in their respective non-volatile storage devices 403.

With reference to FIG. 6E, computing device 400₃ might then request to add block 101₃ to the blockchain, and a request is sent to computing devices 400₁ and 400₂ (and any other nodes) in the same manner described with reference to FIGS. 6B and 6C. If block 101₃ is authenticated by computing devices 400₁ and 400₂, then block 101₃ will be added to blockchain 100₂ to generate blockchain 100₃.

Another aspect of the prior art includes client-server video game systems. With reference to FIG. 7A, video game system 700 comprises server 702 and client 701 operated by User X. Here, server 702 and client 701 can comprise similar hardware components as computing device 400. Server 702 might operate an on-line video game, which client 701 joins. As part of the video game, server 702 might make digital item 703 available to its users for purchase. An example of digital item 703 might be a weapon in a “first person shooter” video game, an article of clothing for a user's online character, a music or video clip, access to special content, enhancements to the video game experience such as an increase in rank or level, or any other digital item.

In the prior art, server 702 and client 701 would engage in a transaction. For example, server 703 might provide digital item 703 to client 701 in exchange for payment, such as by credit card or online payment service.

One drawback of prior art method video game system 700 is that digital item 703 typically becomes obsolete and relatively worthless at some point in time. For example, with reference to FIG. 7B, if server 702 discontinues the video game, or if user X completes the video game, then digital item 703 might become non-existent or useless as to user X. This is an inefficient and wasteful aspect of the prior art. Digital items in the prior art are diminishing assets that ultimately have no value.

What is needed is an improved video game system that provides inherent, reserved value for each digital item at the time of purchase so that the digital item can later be returned or exchanged based on the reserved value.

### BRIEF SUMMARY OF THE INVENTION

An improved system for generating and tracking digital items in a networked video game system using blockchain technology are disclosed. The system records the sale of a digital item in a blockchain and allocates a reserve of cryptocurrency for the digital item. Thereafter, the digital item can be returned or cancelled in exchange for the cryptocurrency.

### BRIEF DESCRIPTION OF THE DRAWINGS

FIG. 1 depicts a prior art blockchain.

FIG. 2 depicts an example of an iteration of the prior art blockchain.

FIG. 3 depicts an example of another iteration of the prior art blockchain.

FIG. 4 depicts hardware components of a prior art computing device.

FIG. 5 depicts software components of a computing device.

FIGS. 6A, 6B, 6C, 6D, and 6E depict a sequence of adding blocks to an existing blockchain.

FIG. 7A depicts the purchase of a digital item in a prior art video game system.

FIG. 7B depicts the impact of the digital item becoming obsolete in the prior art video game system.

FIG. 8 depicts an embodiment of a video game system utilizing blockchain technology.

FIG. 9 depicts the addition of a new block to the blockchain of the video game system.

FIGS. 10A and 10B depict the impact of the digital item becoming obsolete in the video game system.

FIG. 11 depicts the purchase of a second digital item using cryptocurrency obtained from a transaction involving a first digital item.

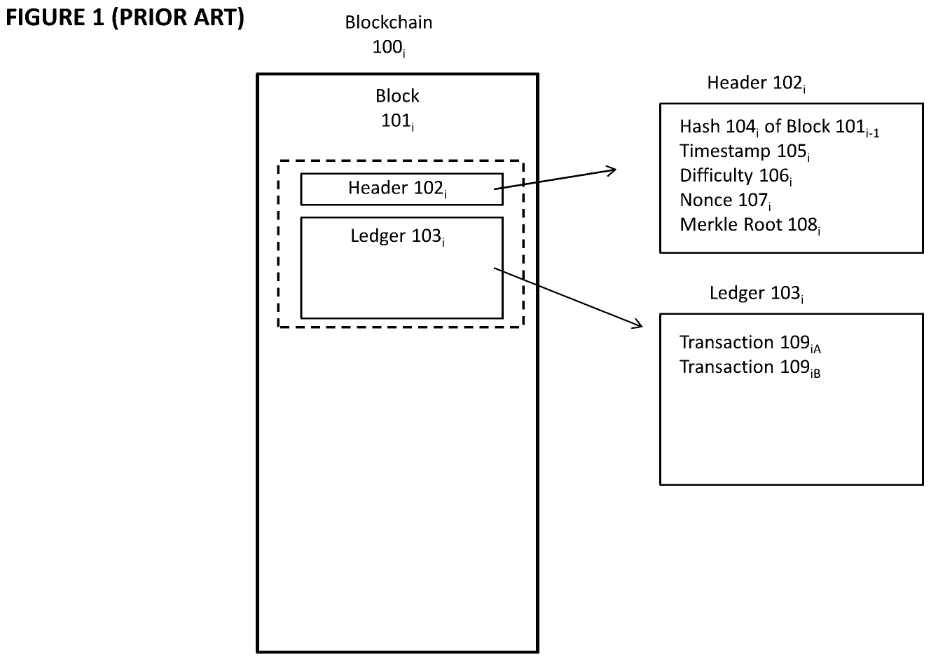

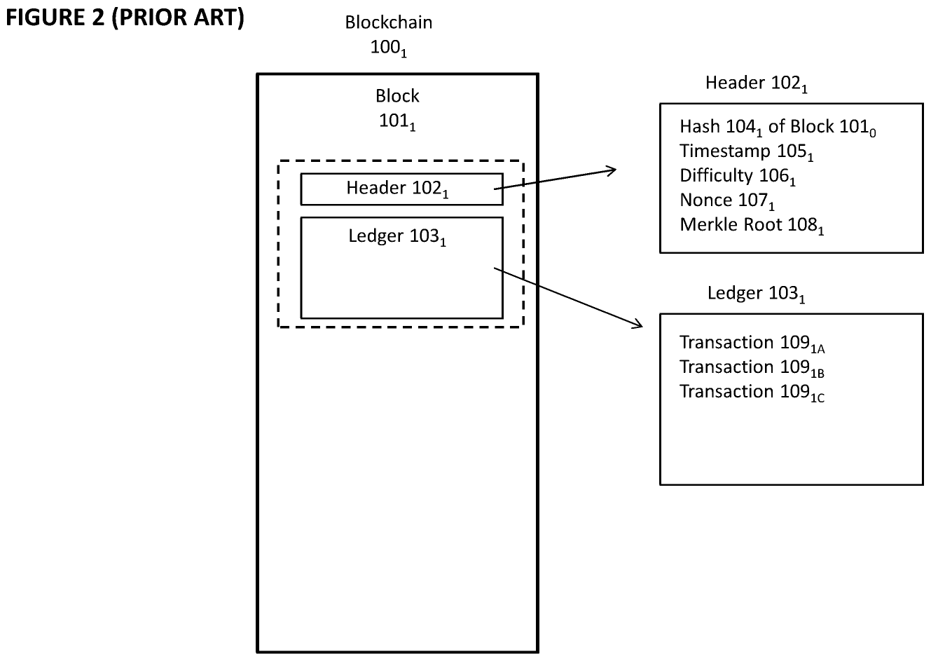

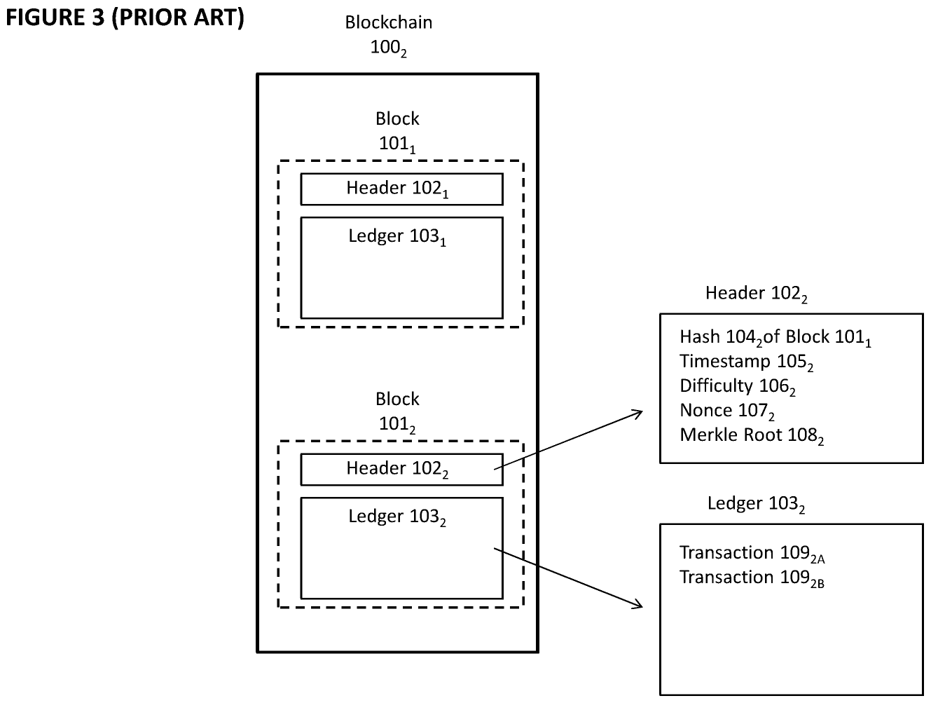

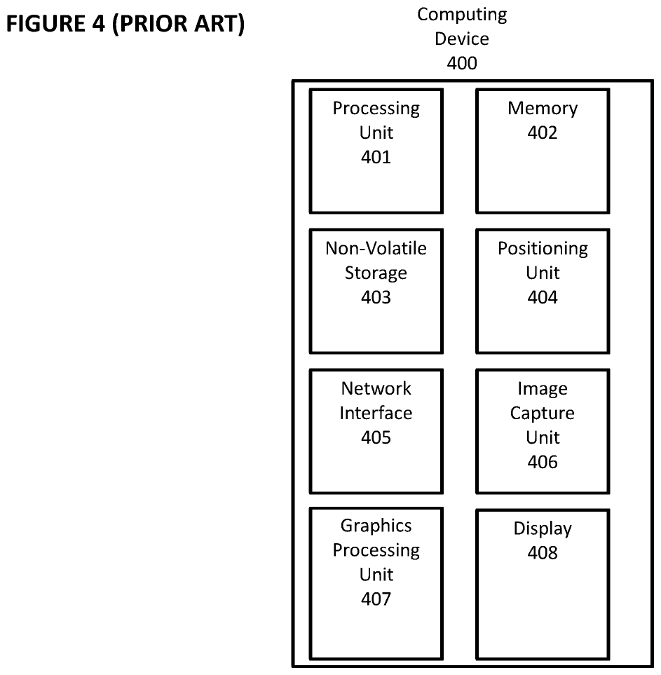

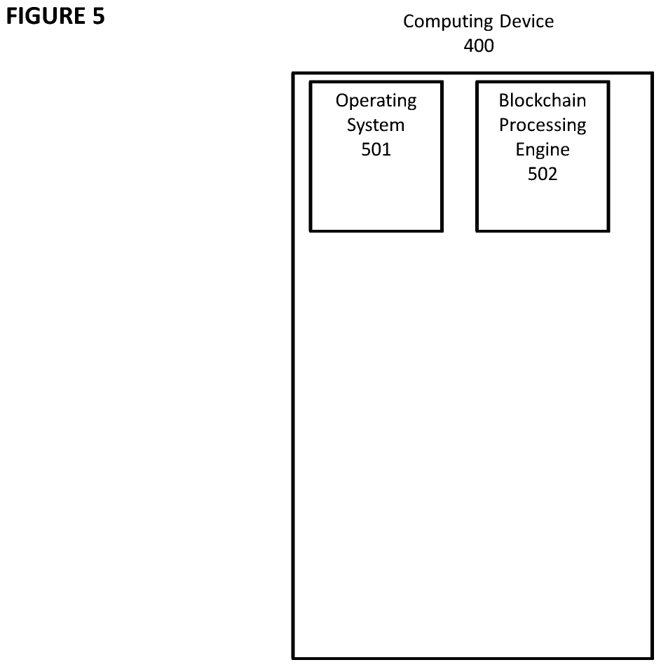

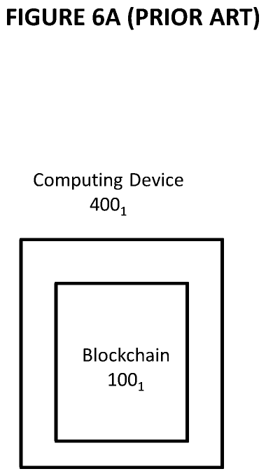

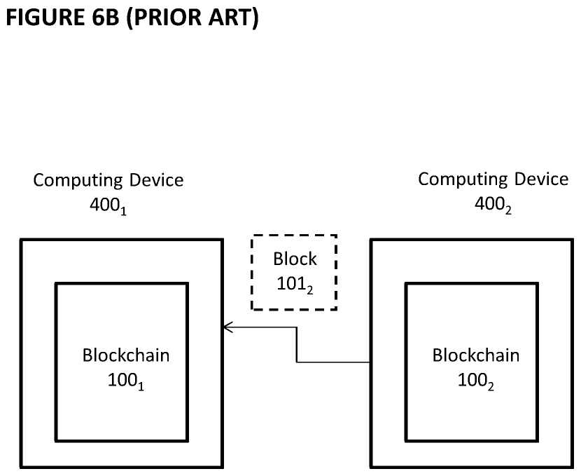

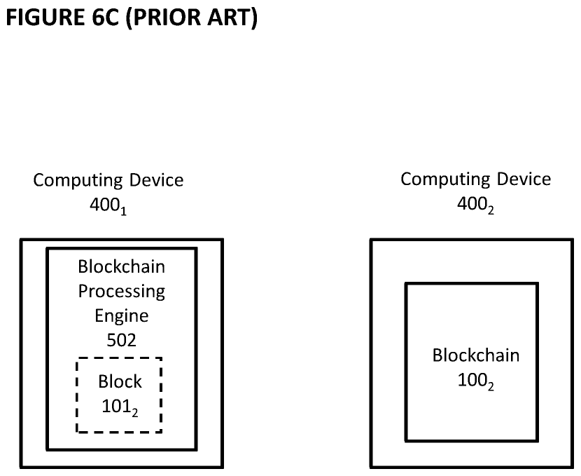

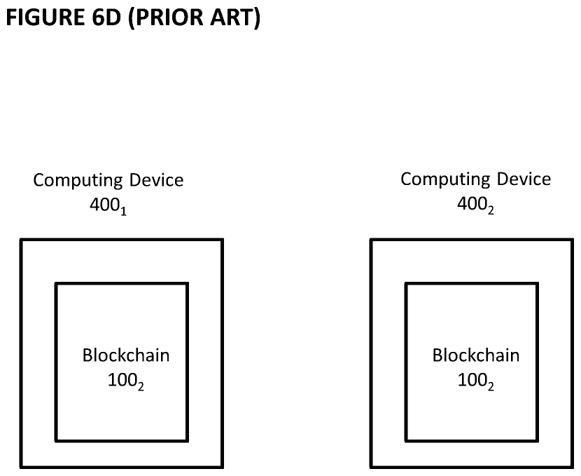

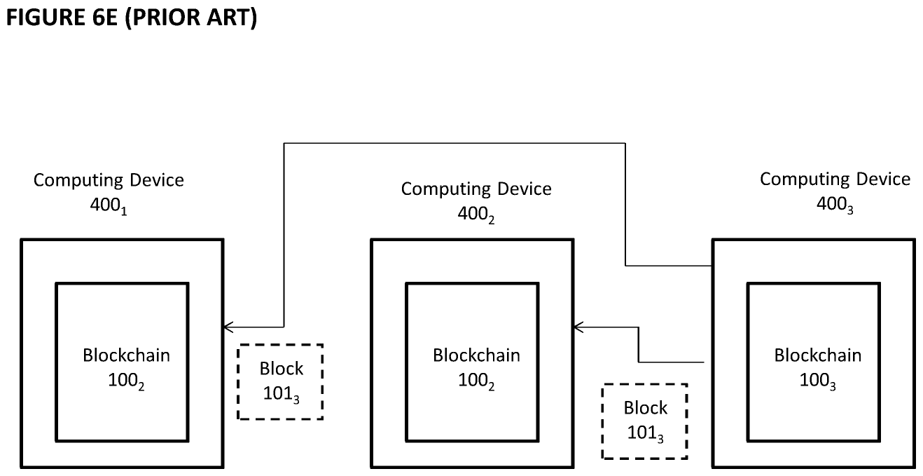

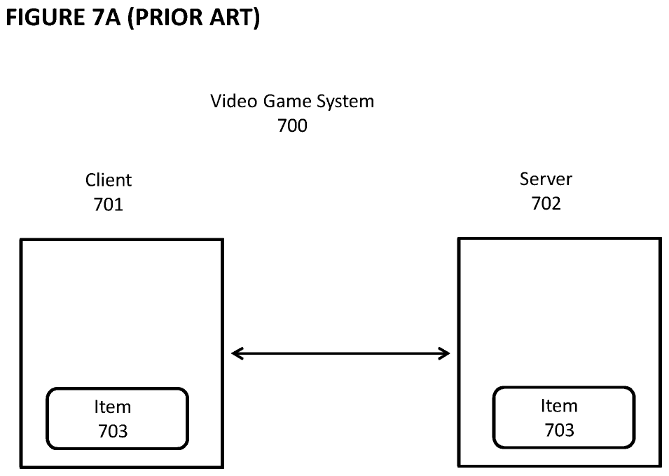

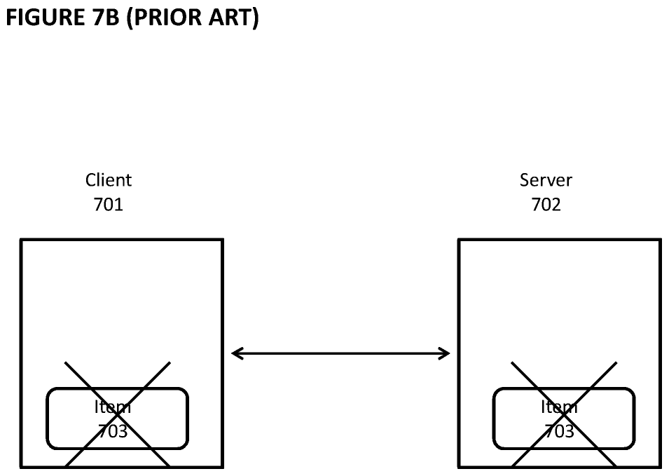

### DETAILED DESCRIPTION OF THE INVENTION

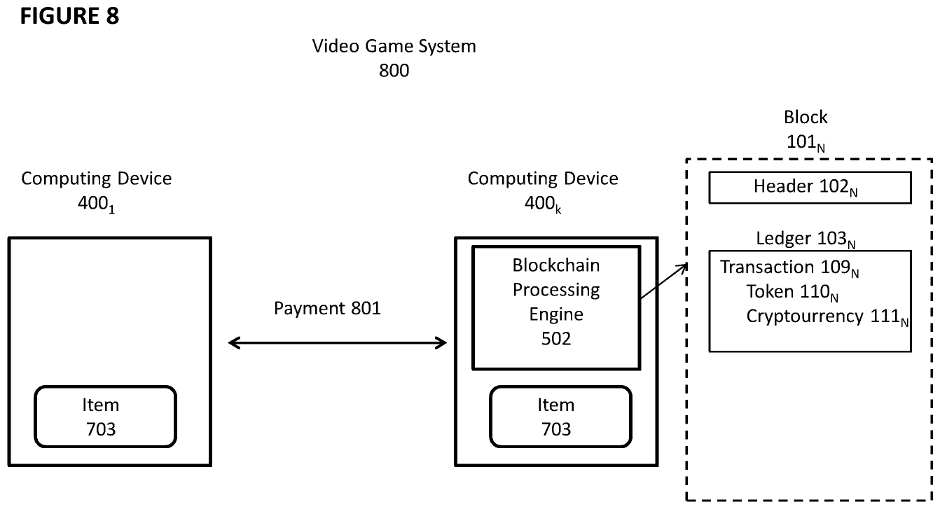

FIG. 8 depicts video game system 800, which in this example comprises computing device 400₁ and computing device 400ₖ, which together operate a video game in which user X participates using computing device 400₁. It will be appreciated that many other computing devices 400 can also participate in the same video game. Computing device 400ₖ comprises blockchain processing engine 502 and is a node.

In the example of FIG. 8, user X initiates the purchase of digital item 703 from computing device 400ₖ in return for payment 801. Payment 801 can be made by credit card or online payment service or by using cybercurrency such as the cybercurrency described below.

Blockchain processing engine 502 in computing device 400ₖ then generates block 101_{N} to record the purchase transaction and to store reserved value for digital item 703 in the form of cryptocurrency, which involves a three-step process:
1. A smart contract on the blockchain is activated and creates a token which represents a digital item. In this example, the smart contract is recorded as transaction 109_{N}, which comprises token 110_{N}. Token 110_{N} represents digital item 703.
2. A reserve amount of cryptocurrency is held in escrow and attached to the digital item. Here, transaction 109_{N} comprises cryptocurrency 111_{N}, which represents an amount of cryptocurrency (e.g., 0.5 Enjin Coins) associated with digital item 703. The smart contract recorded in transaction 109_{N} ensures this reserve amount of cryptocurrency cannot be released unless digital item 703 is destroyed. Optionally, instead of cryptocurrency 111_{N}, traditional money (e.g., US dollars) can be recorded.
3. A number of smart contracts which represent specific attributes for digital item 703 optionally can be activated and stored as part of transaction 109_{N} or in another transaction. These attributes can include:
   a. Whether digital item 703 is tradeable: Tradeable items can be equipped and traded normally between users.
   b. Whether digital item 703 is bound to user X: Bound items cannot be traded but can be melted by its owner (here, user X).
   c. Whether digital item 703 can be transferred only to whitelisted addresses: This restricts transfers outside of whitelisted addresses.
   d. Whether digital item 703 can be combined with other items: These enables token bundles which combine multiple tokens into one.
   e. Whether digital item 703 is part of a fixed maximum supply: This pre-sets a static supply of rare items (e.g., only 100 instantiations of a particular item can exist).
   f. Whether digital item 703 is subject to an annual supply % increase: This provides a dynamic supply that enables item inflation over time.
   g. Whether digital item 703 is subject to an annual supply % decrease: This provides a dynamic supply that enables item deflation over time.
   h. Whether digital item 703 is subject to a periodic increment/decrement by a fixed amount: This provides a dynamic supply which is altered due to demand.
   i. Whether digital item 703 can be rented: This option allows users to rent the item to another user and receive payment in return. Rentals can be set for fixed amounts of time and returns are automatic.
   j. Whether digital item 703 is subject to sales commissions: Minters of an item can opt to earn commission on all sales of that item.
   k. Whether digital item 703 is subject to melting commissions: Minters of an item can opt to earn commission on all melting of that item.

In FIG. 8, computing device 400ₖ records transaction 109_{N} in block 101_{N}, with the transaction detail being stored in ledger 103_{N}. Here transaction 109_{N} might indicate that user X purchased digital item 703 and that cryptocurrency 111_{N} is being held in reserve for digital item 703.

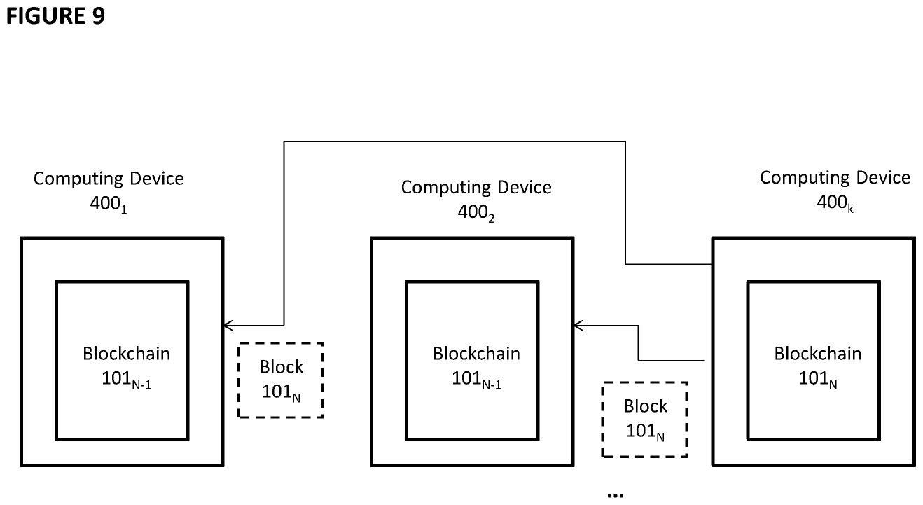

With reference to FIG. 9, computing device 400ₖ then requests all other computing devices that previously stored blockchain 100_{N-1} (i.e, the nodes) to record block 101_{N} in its blockchain and to store new iteration blockchain 100_{N}. Here, two exemplary devices are shown, computing devices 400₁ and 400₂.

Computing devices 400₁ and 400₂ authenticate the request, for example, by using blockchain processing engine 502 to compare the hash 404_{N} in block 101_{N} with a real-time hash calculated using block 101_{N-1} or its header. If a match is found, then computing devices 400 updates blockchain 100_{N-1} to include block 101_{N}, thereby creating and storing blockchain 100_{N}.

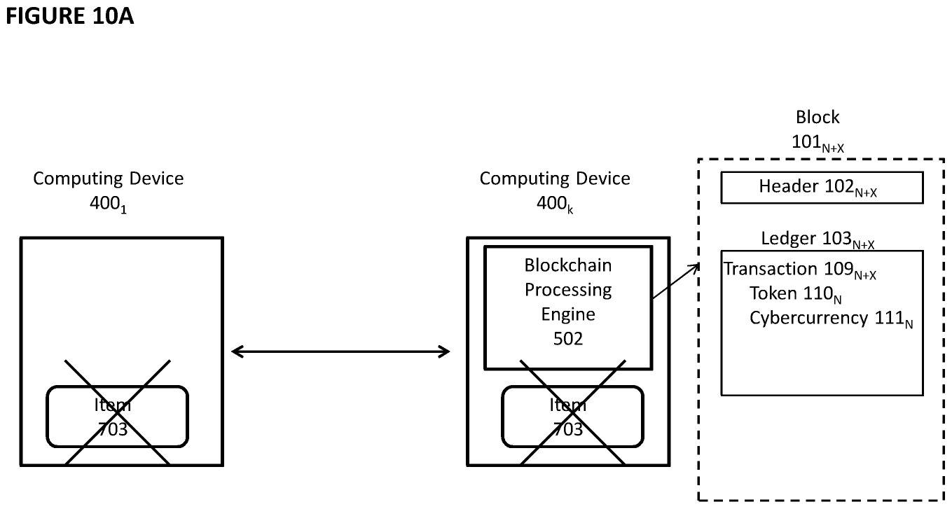

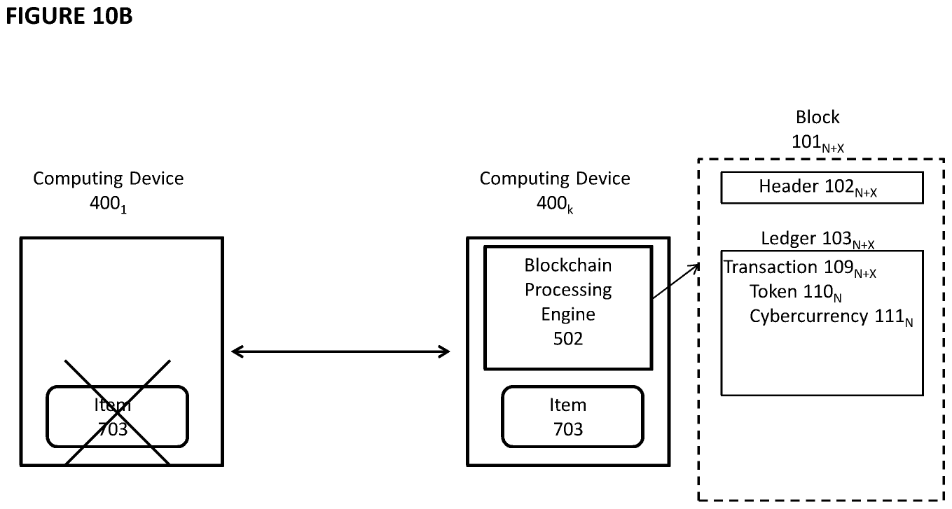

Unlike in the prior art, user X has options for recouping value if item 703 becomes obsolete. In FIG. 10A, computing device 400ₖ stops operating the video game (perhaps because usership has decreased or the company is ending its business operations). Computing device 400ₖ then will record new transaction 109_{N+X} in ledger 103_{N+X} in block 101_{N+X} to indicate that digital item 703 is being cancelled and cryptocurrency 111_{N} is being provided to user X. User X then can use cryptocurrency 111_{N} to purchase other items, or to use cryptocurrency 111_{N} in any other transaction that accepts that form of cryptocurrency.

FIG. 10B depicts another potential scenario. Here, user X no longer wants to own digital item 703 (perhaps because user X has completed the video game or no longer wishes to play the video game or because he or she wishes to replace digital item 703 with a different item). Here, computing device 400₁ will send a request to computing device 400ₖ, which will then “melt” digital item 703 by indicating that token 110_{N} for digital item 703 is now cancelled, and will provide cryptocurrency 111_{N} to User X and/or to the operator of computing device 400ₖ (who can be referred to as a “minter”). This involves a two-step process:
1. The amount of cryptocurrency (111_{N}) held within the melted item is removed and part or all of it goes to the owner of the item (user X), and optionally, part of it goes to the minter. The percentage allocated to the owner and minter is pre-set when item 703 is first created, and, optionally, can be recorded in transaction 109_{N} at the time of sale.
2. Item 703 is effectively removed from blockchain 100 when block 101_{N+X} is added to the blockchain, and token 110_{N} is no longer available as a token.

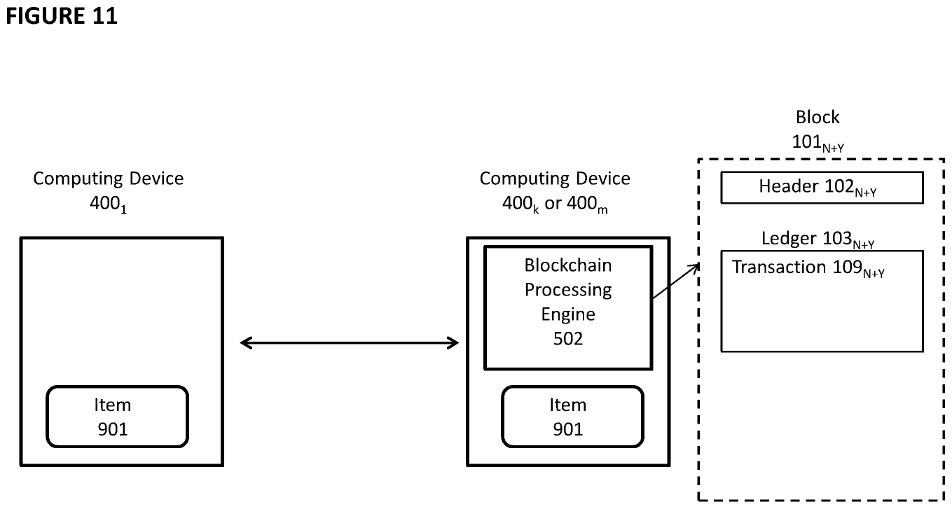

With reference to FIG. 11, at some point after the events of FIG. 10A or 10B, user X wishes to purchase digital item 901 from computing device 400ₖ or from another computing device 400ₘ (which also is a node for blockchain 100_{N}). Unlike in the prior art, user X does not need to provide additional payment for digital item 901. Rather, computing device 400ₖ or computing device 400ₘ can apply cryptocurrency 111_{N} to the purchase. The purchase will be recorded as a new transaction 109_{N+Y} recorded in new block 101_{N+Y}.

It is to be understood that the present invention is not limited to the embodiment(s) described above and illustrated herein but encompasses any and all variations evident from the above description. For example, references to the present invention herein are not intended to limit the scope of any claim or claim term, but instead merely make reference to one or more features that may be eventually covered by one or more claims.

What is claimed is:

1. A computing device comprising a processing unit, memory, and non-volatile storage, the non-volatile storage storing a block, wherein the block is part of a blockchain, the block comprising:
a header comprising:
a hash, generated by the processing unit, of a previous block in the blockchain; and
a timestamp; and
a ledger comprising transaction data for a purchase of a digital item for use in a video game, the transaction data comprising:
a token associated with the digital item and comprising attribute data for the digital item;
a cryptocurrency value for the digital item.

2. The computing device of claim 1, wherein the attribute data comprises data indicating whether the digital item is tradeable.

3. The computing device of claim 1, wherein the attribute data comprises data indicating whether the digital item is bound to an identified user.

4. The computing device of claim 1, wherein the attribute data comprises data indicating whether the digital item can be transferred only to a predetermined set of identified users.

5. The computing device of claim 1, wherein the attribute data comprises data indicating whether the digital item can be combined with other items.

6. The computing device of claim 1, wherein the attribute data comprises data indicating whether the digital item is part of a fixed maximum supply.

7. The computing device of claim 1, wherein the attribute data comprises data indicating whether the digital item us subject to an annual supply percentage increase.

8. The computing device of claim 1, wherein the attribute data comprises data indicating whether the digital item is subject to an annual supply percentage decrease.

9. The computing device of claim 1, wherein the attribute data comprises data indicating whether the digital item is subject to a periodic adjustment by a fixed amount.

10. The computing device of claim 1, wherein the attribute data comprises data indicating whether the digital item can be rented.

11. The computing device of claim 1, wherein the attribute data comprises data indicating whether the digital item is subject to a sales commission.

12. The computing device of claim 1, wherein the attribute data comprises data indicating whether the digital item is subject to a commission for melting of the digital item.

13. A method for facilitating the transaction of a digital item, comprising:
purchasing, by a first computing device, a digital item from a second computing device;
generating and storing, by the second computing device, a block associated with the purchasing step, wherein the block is part of a blockchain and comprises a header comprising a hash of a previous block in the blockchain, and a timestamp, and a ledger comprising transaction data for a purchase of a digital item for use in a video game, the transaction data comprising a token associated with the digital item and comprising attribute data for the digital item, and a cryptocurrency value for the digital item;
altering, by the first computing device or the second computing device, the digital item to render it unusable in the video game; and
transferring, by the second computing device, the cryptocurrency value to the first computing device.

14. The computing device of claim 13, wherein the attribute data comprises data indicating whether the digital item is tradeable.

15. The computing device of claim 13, wherein the attribute data comprises data indicating whether the digital item is bound to an identified user.

16. The computing device of claim 13, wherein the attribute data comprises data indicating whether the digital item can be transferred only to a predetermined set of identified users.

17. The computing device of claim 13, wherein the attribute data comprises data indicating whether the digital item can be combined with other items.

18. The computing device of claim 13, wherein the attribute data comprises data indicating whether the digital item is part of a fixed maximum supply.

19. The computing device of claim 13, wherein the attribute data comprises data indicating whether the digital item us subject to an annual supply percentage increase.

20. The computing device of claim 13, wherein the attribute data comprises data indicating whether the digital item is subject to an annual supply percentage decrease.

21. The computing device of claim 13, wherein the attribute data comprises data indicating whether the digital item is subject to a periodic adjustment by a fixed amount.

22. The computing device of claim 13, wherein the attribute data comprises data indicating whether the digital item can be rented.

23. The computing device of claim 13, wherein the attribute data comprises data indicating whether the digital item is subject to a sales commission.

24. The computing device of claim 13, wherein the attribute data comprises data indicating whether the digital item is subject to a commission for melting of the digital item.

25. A method for facilitating the transfers of a first digital item and a second digital item, comprising:
purchasing, by a first computing device, a first digital item from a second computing device;
generating and storing, by the second computing device, a first block associated with the purchasing of the first digital item, wherein the first block is part of a blockchain and comprises a header comprising a hash of a previous block in the blockchain, and a timestamp, and a ledger comprising transaction data for a purchase of the first digital item for use in a first video game, the transaction data comprising a token associated with the first digital item and comprising attribute data for the first digital item, and a cryptocurrency value for the first digital item;
altering, by the first computing device or the second computing device, the first digital item to render it unusable;
purchasing, by the first computing device, a second digital item from a third computing device, wherein the first computing device transfers the cryptocurrency value for the first digital item to the third computing device; and
generating and storing, by the third computing device, a second block associated with the purchasing of the second digital item, wherein the second block is part of the blockchain and comprises a header comprising a hash of the first block, and a timestamp, and a ledger comprising transaction data for a purchase of the second digital item for use in a second video game, the transaction data comprising a token associated with the second digital item and comprising attribute data for the second digital item, and a cryptocurrency value for the second digital item.

26. The method of claim 25, wherein the attribute data of the first block comprises data indicating whether the first digital item is tradeable and the attribute data of the second block comprises data indicating whether the second digital item is tradeable.

27. The method of claim 25, wherein the attribute data of the first block comprises data indicating whether the first digital item is bound to an identified user and the attribute data of the second block comprises data indicating whether the second digital item is bound to an identified user.

28. The method of claim 25, wherein the attribute data of the first block comprises data indicating whether the first digital item can be transferred only to a predetermined set of identified users and the attribute data of the second block comprises data indicating whether the second digital item can be transferred only to a predetermined set of identified users.

29. The method of claim 25, wherein the attribute data of the first block comprises data indicating whether the first digital item can be combined with other items and the attribute data of the second block comprises data indicating whether the second digital item can be combined with other items.

30. The method of claim 25, wherein the attribute data of the first block comprises data indicating whether the first digital item is part of a fixed maximum supply and the attribute data of the second block comprises data indicating whether the second digital item is part of a fixed maximum supply.

31. The method of claim 25, wherein the attribute data of the first block comprises data indicating whether the first digital item us subject to an annual supply percentage increase and the attribute data of the second block comprises data indicating whether the second digital item us subject to an annual supply percentage increase.

32. The method of claim 25, wherein the attribute data of the first block comprises data indicating whether the first digital item is subject to an annual supply percentage decrease and the attribute data of the second block comprises data indicating whether the second digital item is subject to an annual supply percentage decrease.

33. The method of claim 25, wherein the attribute data of the first block comprises data indicating whether the first digital item is subject to a periodic adjustment by a fixed amount and the attribute data of the second block comprises data indicating whether the second digital item is subject to a periodic adjustment by a fixed amount.

34. The method of claim 25, wherein the attribute data of the first block comprises data indicating whether the first digital item can be rented and the attribute data of the second block comprises data indicating whether the second digital item can be rented.

35. The method of claim 25, wherein the attribute data of the first block comprises data indicating whether the first digital item is subject to a sales commission and the attribute data of the second block comprises data indicating whether the second digital item is subject to a sales commission.

36. The method of claim 25, wherein the attribute data of the first block comprises data indicating whether the first digital item is subject to a commission for melting of the first digital item and the attribute data of the second block comprises data indicating whether the second digital item is subject to a commission for melting of the second digital item.
